(19) United States
(12) Patent Application Publication
(10) Pub. No.: US 2023/0276124 A1
(43) Pub. Date: Aug. 31, 2023

(54) UNIT, IMAGING APPARATUS, AND STORAGE MEDIUM

(71) Applicant: CANON KABUSHIKI KAISHA, Tokyo (JP)

(72) Inventor: JUNICHI SUZUKI, Tochigi (JP)

(21) Appl. No.: 18/173,558

(22) Filed: Feb. 23, 2023

(30) Foreign Application Priority Data
Feb. 28, 2022 (JP) 2022-030254

(51) Int. Cl. H04N 23/661; H04N 23/663; H04N 1/21

(52) U.S. Cl. CPC H04N 23/662; H04N 23/663; H04N 1/2125

(57) ABSTRACT

A unit including a processing unit configured to generate display data about at least one of a state and setting of the unit, and a transmission unit configured to transmit information, wherein the unit is communicably connected to another unit including a display unit, and wherein the processing unit causes the transmission unit to transmit the display data to the other unit based on a notification that the display unit is in a displayable state, from the other unit.

### BACKGROUND OF THE DISCLOSURE

### Field of the Disclosure

The present disclosure relates to a unit, an imaging apparatus, and a storage medium.

### Description of the Related Art

A lens apparatus as a unit (module or imaging unit) in an imaging apparatus such as a television camera includes a user interface (UI) for state check, function setting, and the like.

Further, the lens apparatus is communicably connected to a camera apparatus, and may be communicably connected to various units (accessories) such as an operation apparatus to operate the lens apparatus. The communication is performed based on specific rules (protocol), and various functions are realized by the communication. Some of units other than the lens apparatus also include the UI, and the UI of each of the units can display information about another unit.

Japanese Patent Application Laid-Open No. 2019-075633 discusses a relay apparatus that receives an image signal superimposed with menu generation information (ancillary data) output from the imaging apparatus. The relay apparatus generates a menu image from the menu generation information in response to a control signal from a remote controller, and outputs an image signal superimposed with the menu image. Note that the relay apparatus is an apparatus that receives the image signal from the imaging apparatus, and is not a unit (imaging unit) in the imaging apparatus.

For example, by the UI of the operation apparatus as the imaging unit, state check and setting of a function A and a function B of the lens apparats as the other imaging unit are performable. At this time, in a case where the function A may take a state of X or Y, and the function B may take a state of 0 to 100, contents of a combination of the function and the state are previously specified in the protocol for the units. The operation apparatus generates display information from information received from the lens apparatus based on the protocol, and displays the display information on a UI screen. Therefore, in a case where the contents of the combination are changed (e.g., function C is added, or function A may take state of X, Y, or Z and function B may take state of 0 to 1000), it is necessary to change the protocol. Therefore, firmware update in both of the lens apparatus and the operation apparatus is necessary. The change in contents of the combination is frequently performed with high definition of an image, diversification of imaging purpose, increase in the number of imaging units communicably connected, and increase in difficulty of imaging; however, it is not preferable that the firmware update be performed every time the contents of the combination are changed.

### SUMMARY OF THE DISCLOSURE

An aspect of the disclosure provides, for example, an imaging unit advantageous for information display on another imaging unit.

According to an aspect of the present disclosure, an imaging unit includes a processing unit configured to generate display data about at least one of a state and setting of the imaging unit, and a transmission unit configured to transmit information, wherein the imaging unit is communicably connected to another imaging unit including a display unit, and wherein the processing unit causes the transmission unit to transmit the display data to the other imaging unit based on a notification that the display unit is in a displayable state, from the other imaging unit.

Further features of the present disclosure will become apparent from the following description of exemplary embodiments with reference to the attached drawings.

### BRIEF DESCRIPTION OF THE DRAWINGS

FIG. 1 is a diagram illustrating a configuration example of an imaging apparatus according to a first exemplary embodiment.

FIGS. 2A and 2B are diagrams illustrating a flow of processing according to the first exemplary embodiment.

FIGS. 3A, 3B, and 3C are diagrams each illustrating a user interface (UI) according to the first exemplary embodiment.

FIG. 4 is a diagram illustrating a configuration example of an imaging apparatus according to second and third exemplary embodiments.

FIGS. 5A and 5B are diagrams illustrating a flow of processing according to second and fourth exemplary embodiments.

FIGS. 6A and 6B are diagrams illustrating a flow of another processing according to the second and fourth exemplary embodiments.

FIGS. 7A, 7B, 7C, 7A′, 7B′, and 7C′ are diagrams each illustrating a UI according to the second exemplary embodiment.

FIGS. 8A and 8B are diagrams illustrating a flow of another processing according to the second exemplary embodiment.

FIGS. 9A, 9B, 9C, and 9A′ are diagrams each illustrating another UI according to the second exemplary embodiment.

FIGS. 10A and 10B are diagrams illustrating a flow of processing according to the third exemplary embodiment.

FIGS. 11A, 11B, 11C, 11A′, 11B′, and 11C′ are diagrams each illustrating a UI according to the third exemplary embodiment.

FIGS. 12A, 12B, 12C are diagrams each illustrating another UI according to the third exemplary embodiment.

FIG. 13 is a diagram illustrating a configuration example of an imaging apparatus according to the fourth exemplary embodiment.

FIGS. 14A, 14B, and 14C are diagrams illustrating a flow of processing according to the fourth exemplary embodiment.

FIGS. 15A, 15B, 15C, 15A′, 15B′, and 15C′ are diagrams each illustrating a UI according to the fourth exemplary embodiment.

### DESCRIPTION OF THE EMBODIMENTS

Some exemplary embodiments of the present disclosure will be described below with reference to accompanying drawings. The same members and the like are denoted by the same reference numerals in principle (unless otherwise noted) throughout the drawings for describing the exemplary embodiments, and repetitive descriptions are omitted.

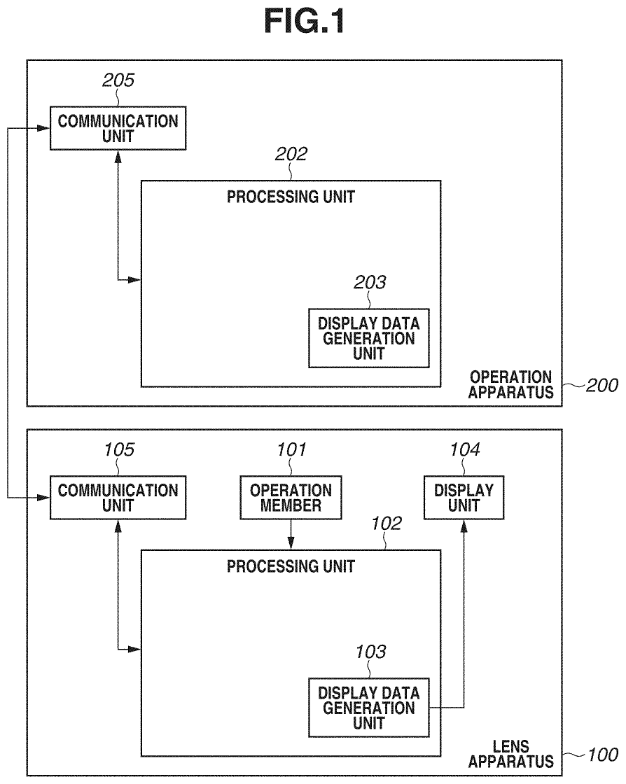

A first exemplary embodiment will be described with reference to FIG. 1 to FIG. 3C. FIG. 1 is a diagram illustrating a configuration example of an imaging apparatus according to the first exemplary embodiment. The imaging apparatus includes a lens apparatus 100 as an imaging unit, and an operation apparatus 200 as an imaging unit. The lens apparatus 100 is attached to a camera apparatus (imaging apparatus main body) that is an imaging unit including an imaging device capturing an image formed by the lens apparatus. In the present exemplary embodiment, the lens apparatus 100 displays information relating to the operation apparatus 200.

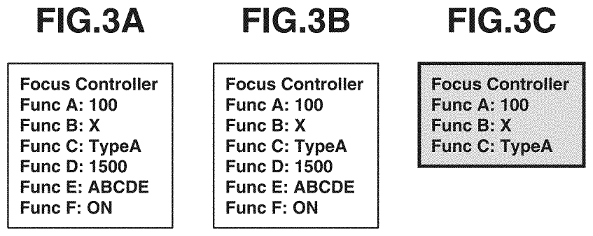

First, the lens apparatus 100 will be described. The lens apparatus 100 includes an operation member 101, a processing unit 102, a display unit 104, and a communication unit 105. The lens apparatus 100 further includes at least one of a zoom lens unit, a focus lens unit, and a diaphragm. The operation member 101 is operable by a user, and is used to switch displayable state/non-displayable state (ON/OFF of display) of the display unit 104, and to operate a menu displayed by the display unit 104. The operation member 101 may include, for example, a push-fit switch and a cross key switch. Types, the number, and the like of switches of the operation member 101 are not limited as long as the operation member 101 can instruct selection, determination, and the like of an item in the menu. For example, an H signal or an L signal is input to the processing unit 102 based on whether the operation member 101 has been operated. Operation/non-operation signals are not limited to the H signal and the L signal as long as the signals can instruct selection, determination, and the like of the item in the menu. The menu display will be described in detail with reference to FIGS. 3A to 3C.

The processing unit 102 may include a single or a plurality of processors (central processing units (CPUs), etc.), and functions as at least a display data generation unit 103 (also simply referred to as generation unit). The display data generation unit 103 generates display data to be displayed on the display unit 104 based on information about a state and setting of the lens apparatus 100 and display data received by the communication unit 105 (reception unit) from the operation apparatus 200, and causes the display unit 104 to display the display data. The generation unit generates the display data about at least one of a state and setting of the imaging unit. The display data generation unit 103 may cause the display unit 104 to display the display data in a case where the display unit 104 is in the displayable state (display ON) by the operation member 101; however, the case is not limited thereto. Further, the display unit 104 includes a display device, configures a user interface (UI), and displays the display data input from the processing unit 102. The display device may include a liquid crystal display or an organic electroluminescence display, but is not limited thereto. The communication unit 105 communicates with the operation apparatus 200, transmits data input from the processing unit 102 to the operation apparatus 200, and receives data from the operation apparatus 200 and outputs the received data to the processing unit 102. In this example, it is sufficient if the communication unit 105 outputs the display data received from the operation apparatus 200 to the processing unit 102. The communication unit 105 may be a transmission unit transmitting the display data.

Next, the operation apparatus 200 will be described. The operation apparatus 200 is an apparatus to operate the lens apparatus 100, and operates, for example, the zoom lens unit and the focus lens unit of the lens apparatus 100. The operation apparatus 200 may include a processing unit 202 and a communication unit 205. In this example, the operation apparatus 200 operates the focus lens unit of the lens apparatus 100. The processing unit 202 may include a single or a plurality of processors (CPUs, etc.), and functions as at least a display data generation unit 203. The display data generation unit 203 generates display data to be transmitted to the lens apparatus 100 based on information about a state and setting of the operation apparatus 200, and outputs the display data to the communication unit 205.

The focus lens unit is operated by operating an operation member of the operation apparatus 200. The processing unit 202 generates an instruction to drive the focus lens unit based on an operation amount of the operation member. The instruction is transmitted to the lens apparatus 100 via the communication unit 205.

The communication unit 205 communicates with the lens apparatus 100. The communication unit 205 transmits information input from the processing unit 202 to the lens apparatus 100, and outputs data received from the lens apparatus 100 to the processing unit 202. In this example, it is sufficient if the communication unit 205 transmits the display data input from the processing unit 202 to the lens apparatus 100. The display data transmitted to the lens apparatus 100 may be, for example, American Standard Code for Information Interchange (ASCII) data (data including ASCII). The ASCII is a character code. Further, a communication protocol is previously determined for a combination of the lens apparatus 100 and the operation apparatus 200 (combination of imaging units), and in this example, the communication protocol can communicate the ASCII data. The ASCII data may be transmitted as it is as data, or data converted (coded) by a predetermined method may be transmitted, and the received data may be converted (decoded) into the ASCII data.

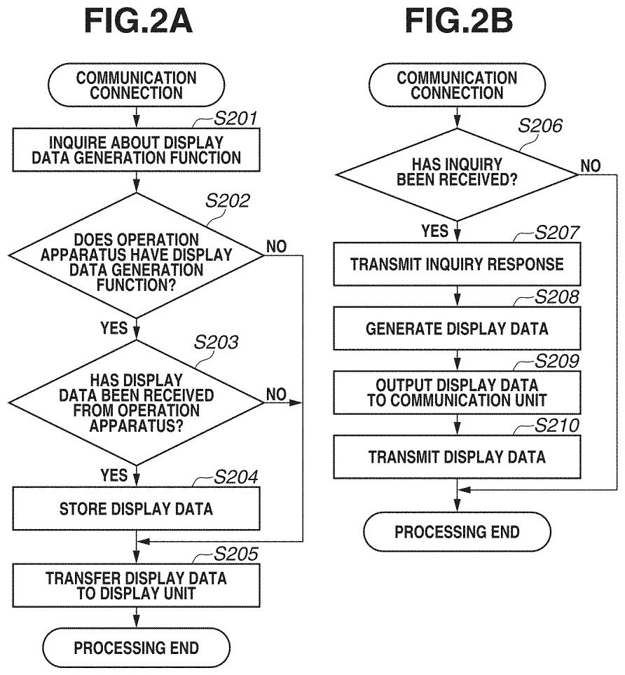

FIGS. 2A and 2B are diagrams illustrating a flow of processing according to the first exemplary embodiment. FIG. 2A illustrates processing performed by the processing unit 102 of the lens apparatus 100, and FIG. 2B illustrates processing performed by the processing unit 202 of the operation apparatus 200.

In FIG. 2A, first, when communication connection is established between the lens apparatus 100 and the operation apparatus 200 after the lens apparatus 100 is turned on, the processing proceeds to step S201. In step S201, a communication command (inquiry information) to check (inquire) whether the operation apparatus 200 communicably connected has a function of generating display data (display data generation function) is transmitted to the operation apparatus 200. In step S202, contents (communication command, inquiry result, or function possession information indicating possession of display data generation function) received from the operation apparatus 200 in response to the communication command transmitted in step S201 are determined. In a case where the operation apparatus 200 has the display data generation function (YES in step S202), the processing proceeds to step S203. In a case where the operation apparatus 200 does not support the display data generation function (NO in step S202), the processing proceeds to step S205.

In step S203, it is checked whether the display data has been received from the operation apparatus 200. In a case where the display data has been received (YES in step S203), the processing proceeds to step S204. In a case where the display data has not been received (NO in step S203), the processing proceeds to step S205. In step S204, the display data generation unit 103 stores the received display data.

In step S205, the stored display data is converted into transfer data to be displayed on the display unit 104, the obtained transfer data is transferred to the display unit 104, and the processing ends. In the present exemplary embodiment, the display data generation unit 103 also stores the display data relating to the lens apparatus 100. In a case where the determination result in step S202 or step S203 is NO, the display data relating to the lens apparatus 100 may be converted into the transfer data. However, the processing is not limited thereto, and in the case where the determination result in step S202 or step S203 is NO, the processing may end.

Next, in FIG. 2B, when the communication connection is established between the lens apparatus 100 and the operation apparatus 200 after the operation apparatus 200 is turned on, the processing proceeds to step S206.

In step S206, it is determined whether the communication command (inquiry information) to check whether the operation apparatus 200 includes the display data generation function has been received from the lens apparatus 100 communicably connected. In a case where the communication command has been received (YES in step S206), the processing proceeds to step S207. In a case where the communication command has not been received (NO in step S206), the processing ends. In step S207, a communication command (inquiry response) indicating that the operation apparatus 200 supports the display data generation function is transmitted.

In step S208, the display data generation unit 203 generates the display data (ASCII data in this example) based on the state and the setting of the operation apparatus 200. In step S209, the display data generated in step S208 is output from the processing unit 202 to the communication unit 205. In step S210, the display data is transmitted from the communication unit 205 to the lens apparatus 100, and the processing ends.

The processing to check whether the operation apparatus 200 supports the display data generation function in step S201 and step S202 and in step S206 and step S207 is performed at least once after the communication connection is established.

FIGS. 3A, 3B, and 3C are diagrams each illustrating a UI according to the first exemplary embodiment. FIG. 3A illustrates the display data generated by the operation apparatus 200, FIG. 3B illustrates the display data stored in the lens apparatus 100, and FIG. 3C illustrates the display contents (UI screen) on the display unit 104 of the lens apparatus 100. As illustrated, the display data in FIG. 3A is stored as the display data in FIG. 3B, and displayed on the display unit 104 in FIG. 3C. In the present exemplary embodiment, as illustrated, although the display contents on the display unit 104 include four rows, the entire display data (seven rows in this example) is transmitted from the operation apparatus 200 to the lens apparatus 100. The display data is not limited thereto, and for example, only the display data necessary for display may be transmitted. To do so, the operation apparatus 200 may receive information about the number of displayable rows or columns and information about a cursor position from the lens apparatus 100, and the operation apparatus 200 may transmit only the display data (or displayable display data) necessary for display. In such a case, an operation event by the operation member 101 is notified to the operation apparatus 200, which enables the operation apparatus 200 to update the display data.

With the above-described configuration, even in a case where display specification in the operation apparatus 200 is changed, only the display data (e.g., ASCII data) transmitted from the operation apparatus 200 to the lens apparatus 100 is changed. According to the flow of the processing illustrated in FIGS. 2A and 2B, change in display specification in the operation apparatus 200 is reflected on the lens apparatus 100. Accordingly, frequency of firmware update in both of the lens apparatus 100 and the operation apparatus 200 may be reduced. In other words, even in a case where the specification is changed in the function of one of the combined imaging units communicably connected to each other, the information relating to the function can be displayed on the other of the combined imaging units without performing firmware update in both of the combined imaging units.

In the present exemplary embodiment, the operation apparatus 200 may include a display unit. Further, the ideas of the present exemplary embodiment may be applied to a case where the information about the lens apparatus 100 is displayed on the display unit of the operation apparatus 200. In a case where the lens apparatus 100 and the operation apparatus 200 are remotely communicably connected to each other, it is preferable that each of the lens apparatus 100 and the operation apparatus 200 can perform state check and setting of the other via either of the UIs.

Further, the ideas of the present exemplary embodiment may be applied to the lens apparatus 100 and the camera apparatus.

In that case, the UI of the camera apparatus may include a display unit (e.g., electronic view finder) excellent in viewability. Accordingly, the state and the setting of the lens apparatus 100 may be checked or changed by the UI of the camera apparatus excellent in viewability. Further, in place of the camera apparatus, the ideas of the present exemplary embodiment are applicable to various apparatuses (imaging units) each communicably connected to the lens apparatus 100.

The display data according to the ideas of the present exemplary embodiment is not limited to the data including the ASCII, and may be data including a character code (code representing at least one of character and figure). Transmission of the display data is not limited to the case where the display unit 104 is in the displayable state (display ON) by the operation member 101. The display data may be transmitted without being limited to that case. For example, the display data may be transmitted in a case where the information about the state or the setting is updated, or in a case where the user or the other imaging unit requests the transmission. Further, the method of checking whether the display data generation function is supported according to the present exemplary embodiment is not limited to the above-described method. The method may be based on information specifying a type or an individual of the imaging unit as long as the method enables check whether the imaging unit communicably connected supports the display data generation function. As described above, according to the present exemplary embodiment, it is possible to provide the imaging unit advantageous in information display on another imaging unit.

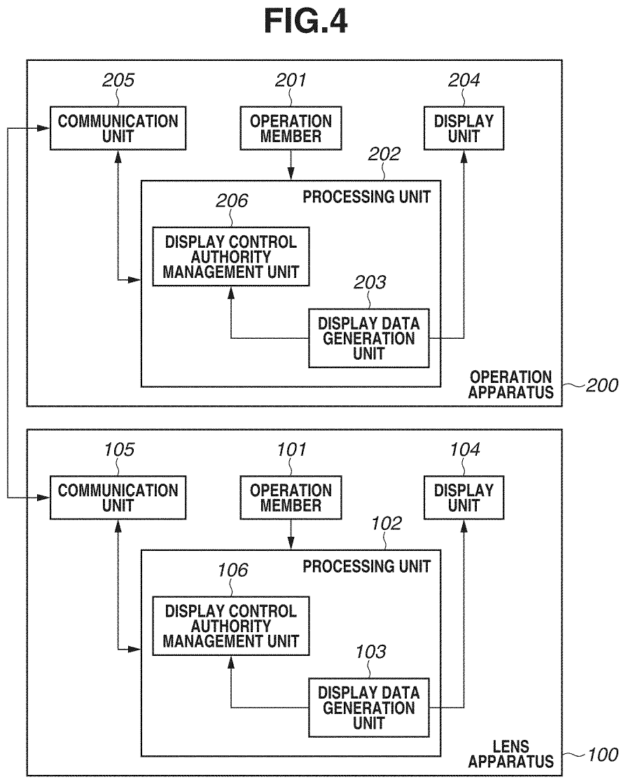

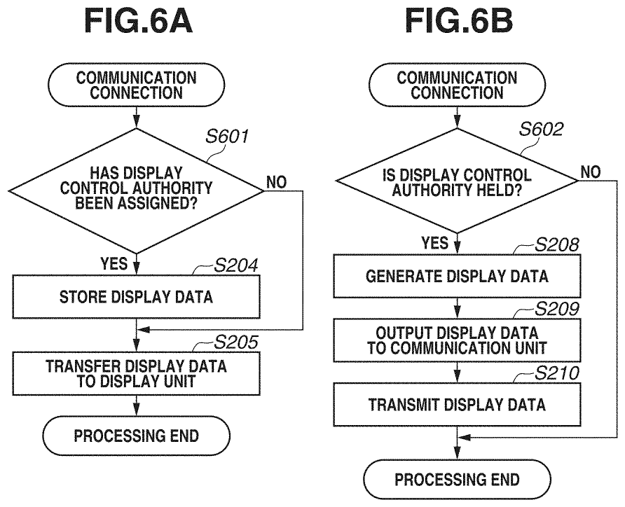

A second exemplary embodiment will be described with reference to FIG. 4 to FIG. 9A′. FIG. 4 is a diagram illustrating a configuration example of an imaging apparatus according to second and third exemplary embodiments. The lens apparatus 100 is provided with a dedicated menu. Thus, the display data is switched between the menu of the lens apparatus 100 and the menu of the operation apparatus 200. In the present exemplary embodiment, the display data (generation unit) is switched based on a display control authority to the display unit. In FIG. 4, components are added to the lens apparatus 100 and the operation apparatus 200 as compared with FIG. 1. In FIG. 4, a display control authority management unit 106 is added to the lens apparatus 100. The display control authority management unit 106 has a function of managing a belonging state of the display control authority, and assigns the display control authority to the imaging unit communicably connected, based on a condition. In the present exemplary embodiment, the display control authority is exchanged based on a UI screen transition condition in the lens apparatus 100. To assign the display control authority, the display control authority management unit 106 causes the communication unit 105 to transmit information indicating assignment. In a case where information indicating that the display control authority has been normally assigned is received from the operation apparatus 200, the information is transmitted to the display control authority management unit 106. The display data generation unit 103 stores the display data from the operation apparatus 200 only in a case where the display control authority has been assigned to the operation apparatus 200. The details thereof will be described with reference to FIGS. 6A and 6B.

Next, the operation apparatus 200 will be described. An operation member 201 and a display control authority management unit 206 are added to the operation apparatus 200. The operation member 201 in the operation apparatus 200 may have a function similar to the function of the operation member 101 in the lens apparatus 100. The display control authority management unit 206 has a function of managing the belonging state of the display control authority. When the information indicating assignment of the display control authority is received by the communication unit 205, the display control authority management unit 206 manages the belonging state of the display control authority as a state where the display control authority is held. When the display control authority is released, the display control authority management unit 206 manages the belonging state of the display control authority as a state where the display control authority is not held. When the display control authority is assigned, the communication unit 205 outputs display control authority assignment to the processing unit 202. When the display control authority is released, the communication unit 205 is caused to transmit information indicating release of the display control authority. Upon receiving the information indicating assignment of the display control authority, the communication unit 205 transmits the information to the display control authority management unit 206. When the information indicating release of the display control authority is input from the display control authority management unit 206, the communication unit 205 transmits the information. The display data generation unit 203 generates the display data and causes the communication unit 205 to transmit the display data only in a case where the display control authority has been assigned to the operation apparatus 200. The details thereof will be described with reference to FIGS. 6A and 6B.

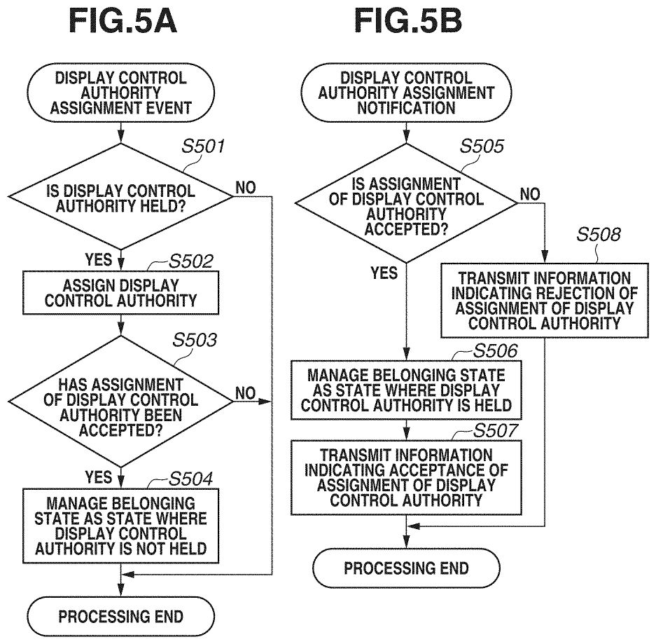

FIGS. 5A and 5B are diagrams illustrating a flow of processing according to the second exemplary embodiment. FIGS. 5A and 5B illustrate a flow of processing relating to the display control authority. FIG. 5A illustrates processing performed by the processing unit 102 of the lens apparatus 100, and FIG. 5B illustrates processing performed by the processing unit 202 of the operation apparatus 200.

First, in FIG. 5A, when a display control authority assignment event occurs, the processing proceeds to step S501. The event occurs when a predetermined condition is satisfied.

In step S501, it is determined whether the lens apparatus 100 holds the display control authority. In a case where the lens apparatus 100 holds the display control authority (YES in step S501), the processing proceeds to step S502. In a case where the lens apparatus 100 does not hold the display control authority (NO in step S501), the processing ends. In step S502, the information indicating assignment of the display control authority is transmitted to the operation apparatus 200 communicably connected, and the processing proceeds to step S503. The information may be, for example, a command notifying assignment of the display control authority.

In step S503, it is determined whether the operation apparatus 200 has accepted assignment of the display control authority by the information transmitted in step S502. In a case where the assignment has been accepted (YES in step S503), the processing proceeds to step S504. In a case where the assignment has not been accepted (NO in step S503), the processing ends. In step S504, the display control authority management unit 106 manages the belonging state of the display control authority as a state where the display control authority is not held, and the processing ends.

Next, processing performed by the processing unit 202 of the operation apparatus 200 will be described with reference to FIG. 5B. When the information indicating assignment of the display control authority is received from the lens apparatus 100, the processing proceeds to step S505. In step S505, it is determined whether to accept assignment of the display control authority. In a case where the assignment is accepted (YES in step S505), the processing proceeds to step S506. In a case where the assignment is not accepted (NO in step S505), the processing proceeds to step S507. The case where the assignment is not accepted may be, for example, a case where a communication load exceeds a threshold, a case where the operation member 201 is under operation, or a preset case.

In step S506, the display control authority management unit 206 manages the belonging state of the display control authority as a state where the display control authority to the lens apparatus 100 is held, and the processing proceeds to step S507. In step S507, information indicating that assignment of the display control authority has been accepted is transmitted to the lens apparatus 100, and the processing ends. The information may be, for example, a command notifying acceptance of the assignment of the display control authority. In step S508, information indicating that the assignment of the display control authority has not been accepted is transmitted to the lens apparatus 100, and the processing ends. The information may be, for example, a command notifying rejection of the assignment of the display control authority.

The processing described with reference to FIGS. 5A and 5B may be applied to a case of releasing the display control authority. In this case, the imaging unit holding the display control authority performs the processing in FIG. 5A, the imaging unit not holding the display control authority performs the processing in FIG. 5B, and “assignment” is replaced with “release”.

FIGS. 6A and 6B are diagrams illustrating a flow of another processing according to the second exemplary embodiment. FIGS. 6A and 6B illustrate a flow of processing relating to generation and exchange of the display data. FIG. 6A illustrates processing performed by the processing unit 102 of the lens apparatus 100, and FIG. 6B illustrates processing performed by the processing unit 202 of the operation apparatus 200. The processing to check whether the operation apparatus 200 supports the display data generation function illustrated in FIGS. 2A and 2B is omitted in FIGS. 6A and 6B; however, the processing may be performed only once after the communication connection between the imaging units is established.

First, in FIG. 6A, when the communication connection with the operation apparatus 200 is established after the lens apparatus 100 is turned on, the processing proceeds to step S601. In step S601, it is determined whether the display control authority has been assigned. In a case where the display control authority has been assigned (YES in step S601), the processing proceeds to step S204. In a case where the display control authority has not been assigned (NO in step S601), the processing proceeds to step S205. In the present exemplary embodiment, the display data generation unit also stores the display data relating to the lens apparatus 100. In a case where the determination result in step S601 is NO, the display data relating to the lens apparatus 100 may be converted into the transfer data. However, the processing is not limited thereto, and in the case where the determination result in step S601 is NO, the processing may end.

Next, processing performed by the processing unit 202 of the operation apparatus 200 will be described with reference to FIG. 6B. First, when the communication connection with the lens apparatus 100 is established after the operation apparatus 200 is turned on, the processing proceeds to step S602. In step S602, it is determined whether the operation apparatus 200 holds the display control authority of the lens apparatus 100. In a case where the operation apparatus 200 holds the display control authority (YES in step S602), the processing proceeds to step S208. In a case where the operation apparatus 200 does not hold the display control authority (NO in step S602), the processing ends.

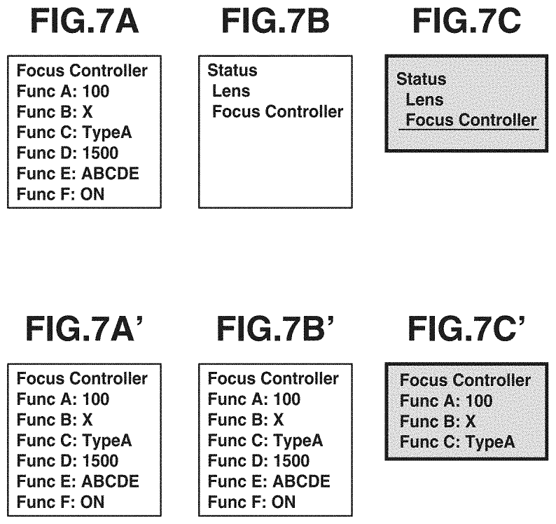

FIGS. 7A, 7B, 7C, 7A′, 7B′, and 7C′ are diagrams each illustrating a UI according to the second exemplary embodiment. FIGS. 7A to 7C illustrate the display data and the UI in the case where the lens apparatus 100 holds the display control authority, and FIGS. 7A′ to 7C′ illustrate the display data and the UI in the case where the operation apparatus 200 holds the display control authority. FIGS. 7A and 7A′ illustrate the display data in the operation apparatus 200, FIGS. 7B and 7B′ illustrate the display data in the lens apparatus 100, and FIGS. 7C and 7C′ illustrate the display contents (UI screens) on the display unit 104 of the lens apparatus 100.

In the present exemplary embodiment, a case where the display control authority to display, on the display unit 104, a screen for state display and setting operation of the operation apparatus 200 (Focus Controller in this example) is assigned to the operation apparatus 200 will be described. When determination operation is performed by the operation member 201 and a display OFF event is generated by the operation member 201 while a cursor is present in the operation apparatus 200 (Focus Controller), the display control authority held by the operation apparatus 200 may be released.

As illustrated in FIGS. 7A, 7B, 7C, 7A′, 7B′, and 7C′, in the case where the lens apparatus 100 holds the display control authority, the display data in the operation apparatus 200 and the display data in the lens apparatus 100 do not match. In contrast, in the case where the display control authority has been assigned to the operation apparatus 200, the display data in the operation apparatus 200 and the display data in the lens apparatus 100 are coincident with each other, and the display data in the operation apparatus 200 is reflected on the display data in the lens apparatus 100.

In a case where an operation event of the operation member 101 is generated, contents of the operation event are transmitted (notified) to the operation apparatus 200. In the above-described manner, the operation apparatus 200 can update the display data by operation of the operation member 101, and the setting operation (setting change) of the operation apparatus 200 can be performed. The assignment of the display control authority is not limited to be requested by the imaging unit holding the display control authority, and may be requested by the imaging unit not holding the display control authority. Further, the assignment of the display control authority may be requested by an apparatus (e.g., (remote) control apparatus (remotely) controlling imaging apparatus) other than the imaging apparatus.

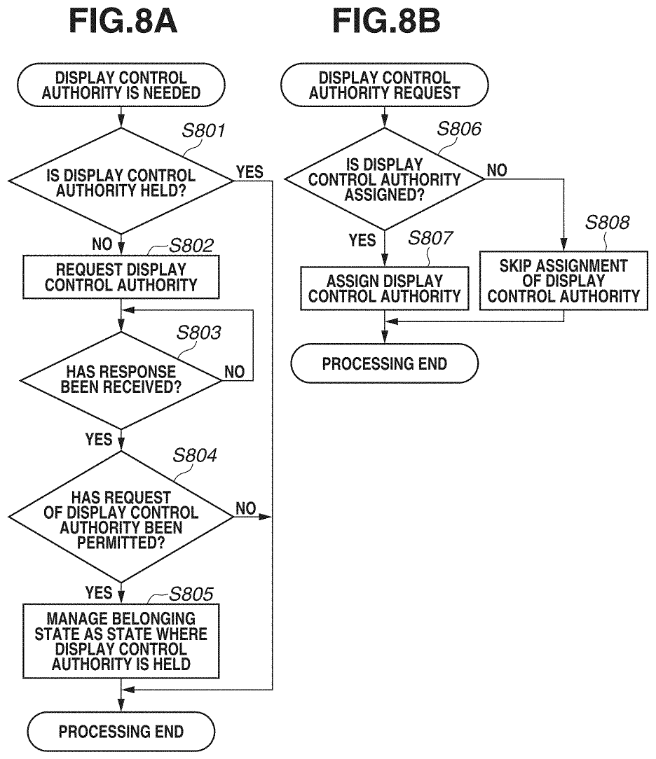

FIGS. 8A and 8B are diagrams illustrating a flow of another processing according to the second exemplary embodiment. FIGS. 8A and 8B illustrate a flow of processing different from the flow of the processing illustrated in FIGS. 6A and 6B. FIG. 8A illustrates processing performed by the processing unit 102 of the lens apparatus 100, and FIG. 8B illustrates processing performed by the processing unit 202 of the operation apparatus 200.

First, in FIG. 8A, in a case where the lens apparatus 100 needs the display control authority, the processing proceeds to step S801. The case where the lens apparatus 100 needs the display control authority may be, for example, a case of causing the display unit 104 to display a warning or the like. In step S801, it is determined whether the lens apparatus 100 holds the display control authority. In a case where the lens apparatus 100 does not hold the display control authority (NO in step S801), the processing proceeds to step S802. In a case where the lens apparatus 100 holds the display control authority (YES in step S801), the processing ends.

In step S802, the display control authority is requested to the operation apparatus 200 communicably connected, and the processing proceeds to step S803. In step S803, it is determined whether a response (response to request described above) from the operation apparatus 200 has been received. In a case where the response has been received (YES in step S803), the processing proceeds to step S804. In a case where the response has not been received (NO in step S803), the processing returns to step S803.

In step S804, it is determined whether the request of the display control authority has been permitted. In a case where the request has been permitted (YES in step S804), the processing proceeds to step S805. In a case where the request has not been permitted (NO in step S804), the processing ends. In step S805, the display control authority management unit 106 manages the belonging state of the display control authority as a state where the display control authority is held, and the processing ends.

Subsequently, processing performed by the processing unit 202 of the operation apparatus 200 will be described with reference to FIG. 8B. In a case where the display control authority is requested from the lens apparatus 100, the processing proceeds to step S806. In step S806, it is determined whether the display control authority is assignable to the lens apparatus 100. In a case where the display control authority is assignable (YES in step S806), the processing proceeds to step S807. In a case where the display control authority is not assignable (NO in step S806), the processing proceeds to step S808. The case where the display control authority is not assignable may be, for example, a case where a warning is displayed on the display unit 104 of the lens apparatus 100, or a preset case.

In step S807, a command indicating that the display control authority is assigned to the lens apparatus 100 is transmitted, and the processing ends. In step S808, a command indicating that the display control authority is not assigned to the lens apparatus 100 is transmitted, and the processing ends.

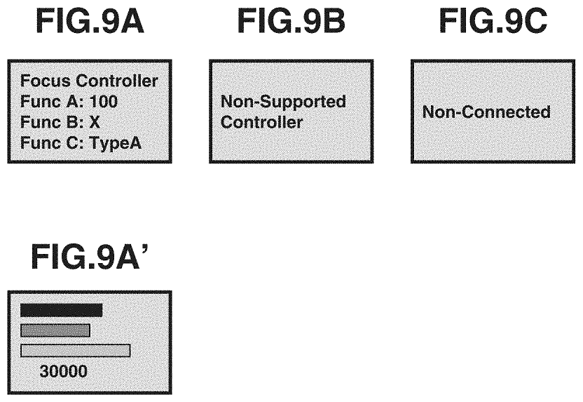

FIGS. 9A, 9B, 9C, and 9A′ are diagrams each illustrating another UI according to the second exemplary embodiment. FIGS. 9A, 9B, 9C, and 9A′ each illustrate the UI in a case where the display data is displayed on the display unit 104 of the lens apparatus 100 and the display unit 204 of the operation apparatus 200, and the operation apparatus 200 holds two pieces of display data. One of the two pieces of display data is transmitted to the lens apparatus 100, and is displayed on the display unit 104 as illustrated in FIG. 9A. The other of the two pieces of display data is displayed on the display unit 204 of the operation apparatus 200 as illustrated in FIG. 9A′. As described above, the two pieces of display data in the operation apparatus 200 may be displayed on the two display units at the same time. Accordingly, for example, in a case where the lens apparatus 100 and the operation apparatus 200 are remotely wirelessly connected to each other, and are operated by different operators, each of the operators can perform state check and setting operation of the corresponding operation target.

Further, the operation apparatus 200 communicably connected to the lens apparatus 100 may not have the display data generation function. Therefore, for example, as illustrated in FIG. 9B, the display unit 104 may display that the operation apparatus 200 not having the display data generation function is connected. Further, in a case where the operation apparatus 200 is not communicably connected to the lens apparatus 100, the display unit 104 may display the fact as illustrated in FIG. 9C. Performing the display as illustrated in FIGS. 9A to 9C based on a connection situation of the operation apparatus 200 to the lens apparatus 100 enables the user to easily recognize the state of the imaging unit (imaging apparatus). As described above, according to the present exemplary embodiment, it is possible to provide the imaging unit advantageous in information display on another imaging unit.

A third exemplary embodiment will be described with reference to FIG. 4 and FIGS. 10A to 12C. In the second exemplary embodiment, the example in which the display control authority for the entire display screen of the display unit is assigned has been described. In the present exemplary embodiment, an example in which the display control authority for a part of the display screen of the display unit is assigned will be described. A configuration example of an imaging apparatus is similar to the configuration example described with reference to FIG. 4. However, each of the display control authority management units 106 and 206 manages belongingness (assignment) of the display control authority only for a specific part of the display screen of the display unit 104.

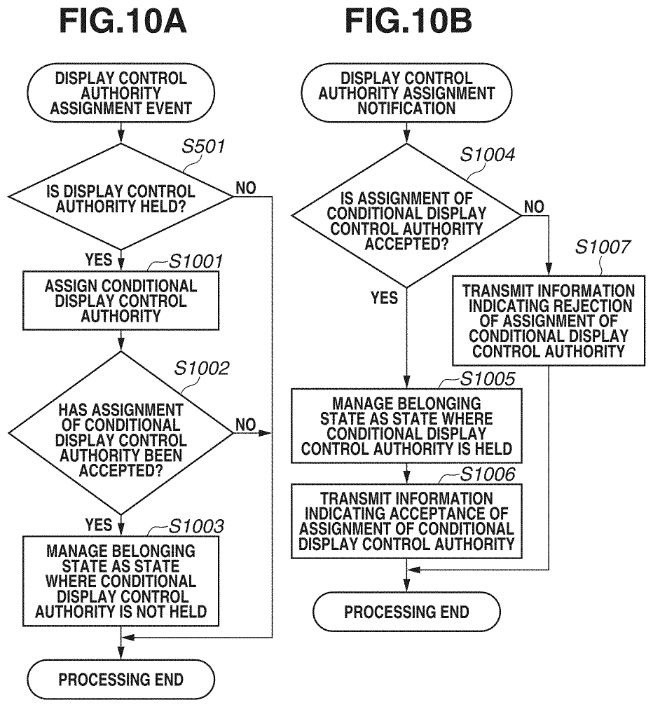

FIGS. 10A and 10B are diagrams illustrating a flow of processing according to the third exemplary embodiment. FIG. 10A illustrates processing performed by the processing unit 102 of the lens apparatus 100, and FIG. 10B illustrates processing performed by the processing unit 202 of the operation apparatus 200.

In FIG. 10A, when a display control authority assignment event occurs, the processing proceeds to step S501. In step S501, it is determined whether the lens apparatus 100 holds the display control authority. In a case where the lens apparatus 100 holds the display control authority (YES in step S501), the processing proceeds to step S1001. In a case where the lens apparatus 100 does not hold the display control authority (NO in step S501), the processing ends. In step S1001, information indicating assignment of a conditional display control authority is transmitted to the operation apparatus 200 communicably connected, and the processing proceeds to step S1002. The condition indicates that, for example, in a case where the display screen of the display unit 104 includes four rows in total, the display control authority only for lower three lows out of the four rows is assigned.

In step S1002, it is determined whether the operation apparatus 200 has accepted assignment of the conditional display control authority. In a case where the assignment has been accepted (YES in step S1002), the processing proceeds to step S1003. In a case where the assignment has not been accepted (NO in step S1002), the processing ends. In step S1003, the display control authority management unit 106 manages the belonging state of the display control authority as a state where the conditional display control authority is not held, and the processing ends. The belonging state may be, for example, a state where the lens apparatus 100 holds the display control authority only for the first row in the display screen of the display unit 104. Note that, in the display screen, the assignment of the conditional display control authority (e.g., assignment of display control authority only for lower three rows out of four rows in total) can be displayed so as to be recognizable by the user.

Next, processing performed by the processing unit 202 of the operation apparatus 200 will be described with reference to FIG. 10B. First, when the information indicating assignment of the conditional display control authority is received from the lens apparatus 100, the processing proceeds to step S1004. In step S1004, it is determined whether to accept assignment of the conditional display control authority. In a case where the assignment is accepted (YES in step S1004), the processing proceeds to step S1005. In a case where the assignment is not accepted (NO in step S1004), the processing proceeds to step S1007. The case where the assignment is not accepted may be, for example, a case where a communication load exceeds a threshold, a case where the operation member 201 is under operation, or a preset case.

In step S1005, the display control authority management unit 206 manages the belonging state of the display control authority as a state where the conditional display control authority to the lens apparatus 100 is held, and the processing proceeds to step S1006. In step S1006, information indicating that the assignment of the conditional display control authority has been accepted is transmitted to the lens apparatus 100, and the processing ends. In step S1007, information indicating that the assignment of the conditional display control authority has not been accepted is transmitted to the lens apparatus 100, and the processing ends.

The processing described with reference to FIGS. 10A and 10B may be applied to a case of releasing the conditional display control authority. In this case, the imaging apparatus holding the conditional display control authority performs the processing in FIG. 10A, the imaging apparatus not holding the conditional display control authority performs the processing in FIG. 10B, and “assignment” is replaced with “release”.

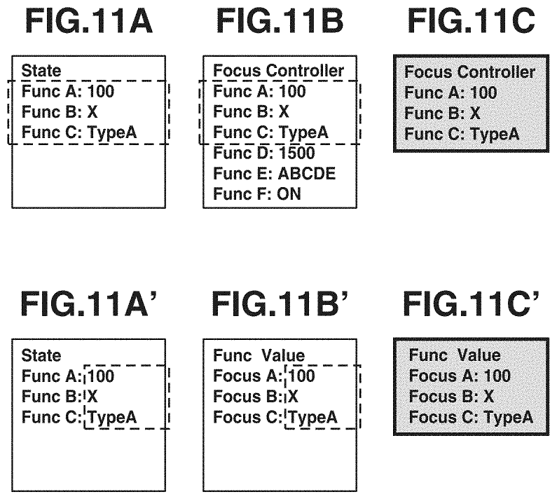

FIGS. 11A, 11B, 11C, 11A′, 11B′, and 11C′ are diagrams each illustrating a UI according to the third exemplary embodiment. FIG. 11A illustrates the display data in the operation apparatus 200, FIG. 11B illustrates the display data in the lens apparatus 100, and FIG. 11C illustrates the UI screen displayed on the display unit 104 of the lens apparatus 100. A dashed line frame in each of the figures indicates a display control authority assignment range (a display area display control authority of which has been assigned) based on the conditional display control authority. The assignment range (display area) may be designated by the lens apparatus 100 (imaging unit including display unit). The display data in the operation apparatus 200 illustrated in FIG. 11A becomes a part of the display data in the lens apparatus 100 illustrated in FIG. 11B, as the display data based on the display control authority assignment range. Further, the display data in the lens apparatus 100 is displayed on the display unit 104 of the lens apparatus 100 as illustrated in FIG. 11C. The display control authority assignment range may be previously determined or may be variable by setting. Further, for example, as illustrated in FIGS. 11A′ to 11C′, the display control authority assignment range may be only a right portion in the lower three rows in the screen.

Further, in a case where an operation event of the operation member 101 occurs in the display control authority assignment range, information relating to the operation event may be transmitted to the operation apparatus 200. As a result, the operation apparatus 200 can update the display data by operation of the operation member 101. Therefore, the setting change of the operation apparatus 200 can also be performed from the lens apparatus 100.

The display control authority assignment range may be limited by the above-described configuration. Therefore, for example, the display control authority for the first row in the UI screen can be prevent from being assigned because the first row in the UI screen preferably follows the display data in the imaging unit including the display unit, as a screen title. For example, in a case where the display relating to the plurality of imaging units is performed, a title “Status” is preferably displayed as “Status of XX unit” for easy recognition.

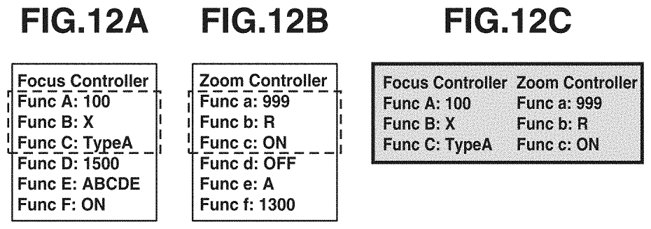

Further, the number of imaging unit connected to the imaging unit including the display unit is not limited to one and may be two. FIGS. 12A, 12B, and 12C are diagrams each illustrating another UI according to the third exemplary embodiment. FIG. 12A illustrates display data (display data 1) in a first imaging unit connected to the imaging unit including the display unit. FIG. 12B illustrates display data (display data 2) in a second imaging unit connected to the imaging unit including the display unit. The two imaging units may be two operation apparatuses operating respective optical members different from each other in the lens apparatus 100. The two operation apparatuses may be, for example, a focus demand (focus controller) and a zoom demand (zoom controller). FIG. 12C illustrates the UI screen displayed on the display unit 104. A dashed line frame in each of the figures indicates the display control authority assignment range. The display data 1 in the first imaging unit illustrated in FIG. 12A and the display data 2 in the second imaging unit illustrated in FIG. 12B are each displayed as the display control authority assignment range on the display unit 104 as illustrated in FIG. 12C. In a case where the display unit 104 includes a large display device excellent in viewability, the display unit 104 can display the display data in the plurality of imaging units as a list. Distributing the display control authority assignment range to each of the imaging units communicably connected is advantageous in display of the display data in the plurality of imaging units as a list.

The limitation target of the display control authority assignment range is not limited to the area in the display screen, and may be, for example, a type of display data. For example, the display control authority assignment range may be limited only to character-string data, and the display data relating to the cursor may be prevented from being assigned. Limiting the assignment target as described above makes it possible to reduce the data amount (information amount) of the transmitted display data. As a result, the load relating to communication of the display data is reduced, which makes it possible to provide the imaging unit advantageous in performance of the imaging apparatus.

Further, a condition to assign the display control authority may be changed for each assignment. Further, based on the data amount (information amount) of the display data, a period or a frequency of update of the display (period or frequency of causing transmission unit to transmit display data) may be changed. Further, the condition to assign the display control authority is not limited to be determined by the imaging unit assigning the display control authority, and may be determined by the imaging unit receiving the display control authority. As described above, according to the present exemplary embodiment, it is possible to provide the imaging unit advantageous in information display on another imaging unit.

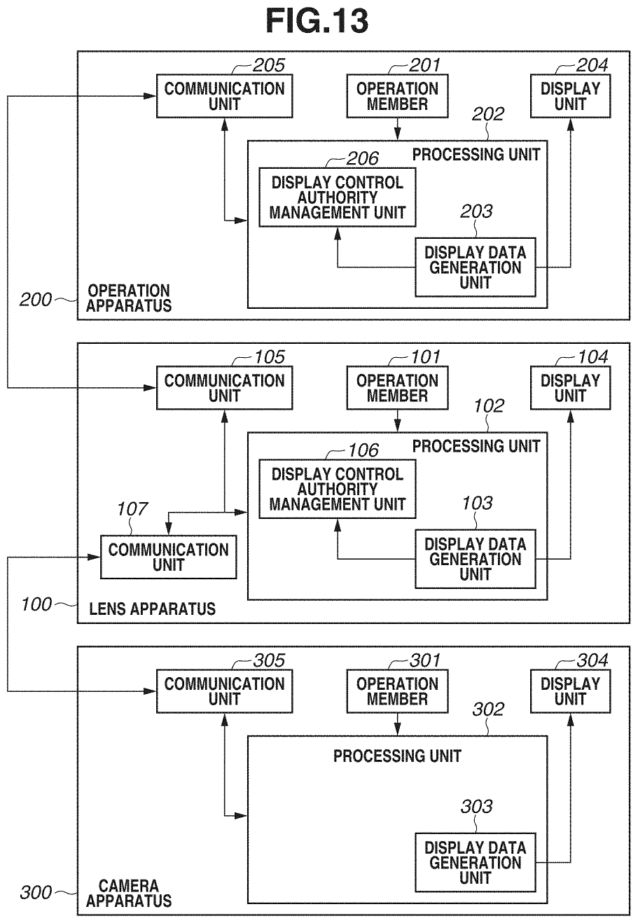

A fourth exemplary embodiment will be described with reference to FIGS. 5A to 6B and FIGS. 13 to 15C′. In the present exemplary embodiment, a remote imaging unit is communicably connected to the imaging unit (e.g., lens apparatus). FIG. 13 is a diagram illustrating a configuration example of an imaging apparatus according to the fourth exemplary embodiment. In the configuration example, a camera apparatus 300 is illustrated. Further, a communication unit 107 communicating with the camera apparatus 300 is added to the lens apparatus 100.

The camera apparatus 300 includes an operation member 301, a processing unit 302, a display data generation unit 303, a display unit 304, and a communication unit 305. In the camera apparatus 300, these units have functions similar to the functions of the operation member 101, the processing unit 102, the display data generation unit 103, the display unit 104, and the communication unit 105 in the lens apparatus 100. The communication unit 305 communicates with the lens apparatus 100. The communication unit 305 transmits data input from the processing unit 302 to the lens apparatus 100, and outputs data (including display data) received from the lens apparatus 100 to the processing unit 302.

The communication unit 107 in the lens apparatus 100 communicates with the camera apparatus 300. The communication unit 107 transmits data (including display data) input from the processing unit 102 to the camera apparatus 300, and outputs data received from the camera apparatus 300 to the processing unit 102.

In the present exemplary embodiment, the display data in the operation apparatus 200 and the display data in the lens apparatus 100 are displayed on the display unit 304 of the camera apparatus 300. Further, a display control authority of the camera apparatus 300 is first assigned to the lens apparatus 100, and the display control authority of the camera apparatus 300 held by the lens apparatus 100 is assigned to the operation apparatus 200. Note that the flow of the processing illustrated in FIGS. 5A and 5B may be applied to assignment of the display control authority. The flow of the processing in FIG. 5A may be applied to the imaging unit assigning the display control authority, and the flow of the processing in FIG. 5B may be applied to the imaging unit receiving the display control authority.

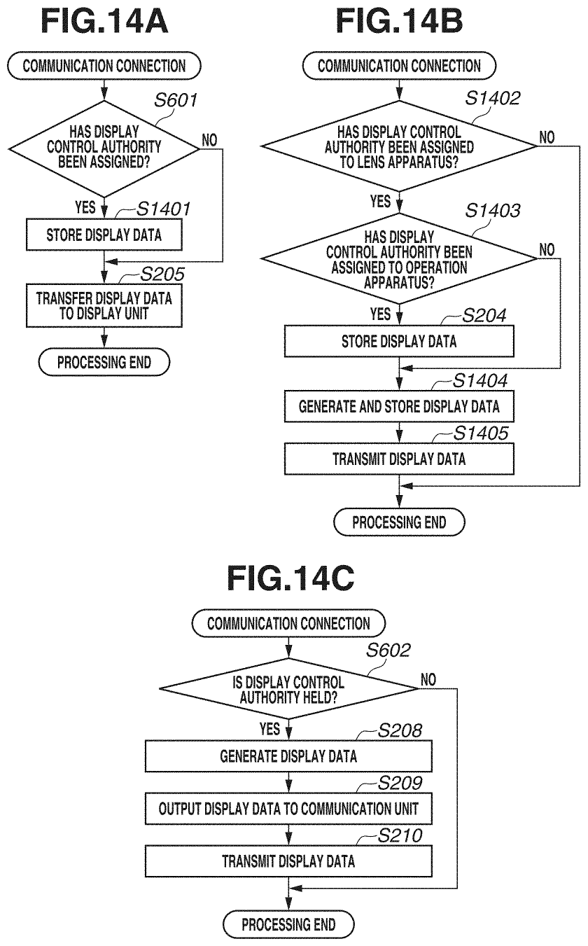

FIGS. 14A to 14C are diagrams illustrating a flow of processing according to the fourth exemplary embodiment. FIG. 14A illustrates processing performed by the processing unit 302 of the camera apparatus 300. FIG. 14B illustrates processing performed by the processing unit 102 of the lens apparatus 100. FIG. 14C illustrates processing performed by the processing unit 202 of the operation apparatus 200. The processing to check whether the operation apparatus 200 supports the display data generation function, illustrated in FIGS. 2A and 2B is omitted in FIGS. 14A to 14C; however, the processing may be performed only once after the communication connection among the imaging units is established.

First, in FIG. 14A, when communication connection with the lens apparatus 100 is established after the camera apparatus 300 is turned on, the processing proceeds to step S601. In step S601, it is determined whether the display control authority has been assigned. In a case where the display control authority has been assigned (YES in step S601), the processing proceeds to step S1401. In a case where the display control authority has not been assigned (NO in step S601), the processing proceeds to step S205. In step S1401, the display data generation unit 303 stores the display data received from the lens apparatus 100, and the processing proceeds to step S205.

In FIG. 14B, first, when communication connection with the operation apparatus 200 and the camera apparatus 300 is established after the lens apparatus 100 is turned on, the processing proceeds to step S1402. In step S1402, it is determined whether the display control authority of the camera apparatus 300 has been assigned to the lens apparatus 100. In a case where the display control authority has been assigned (YES in step S1402), the processing proceeds to step S1403. In a case where the display control authority has not been assigned (NO in step S1402), the processing ends. In step S1403, it is determined whether the display control authority of the camera apparatus 300 has been assigned to the operation apparatus 200. In a case where the display control authority has been assigned (YES in step S1403), the processing proceeds to step S204. In a case where the display control authority has not been assigned (NO in step S1403), the processing proceeds to step S1404.

In step S1404, the display data generation unit 103 generates and stores the display data for the camera apparatus 300, and the processing proceeds to step S1405. In step S1405, the display data stored in step S1404 is transmitted from the communication unit 107 to the camera apparatus 300, and the processing ends.

The processing in FIG. 14C is processing performed by the processing unit 202 of the operation apparatus 200, and is similar to the processing in FIG. 6B. Therefore, descriptions of the processing are omitted.

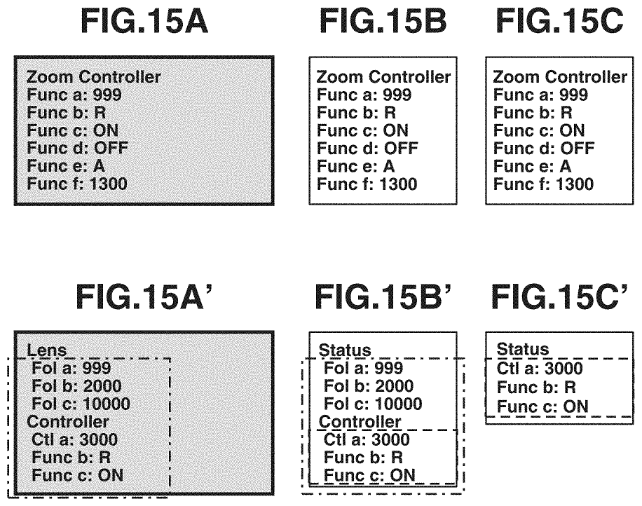

FIGS. 15A, 15B, 15C, 15A′, 15B′, and 15C′ are diagrams each illustrating a UI according to the fourth exemplary embodiment. FIG. 15A illustrates a UI screen displayed on the display unit 304. FIG. 15B illustrates the display data relating to the lens apparatus 100, and FIG. 15C illustrates the display data relating to the operation apparatus 200. The display data relating to the operation apparatus 200 becomes the display data relating to the lens apparatus 100, and the display data relating to the lens apparatus 100 is displayed on the display unit 304 of the camera apparatus 300. FIGS. 15A′ to 15C′ illustrate a case where the display control authority assignment range is limited. In each of the figures, a dashed line frame indicates the range of the display control authority assigned from the lens apparatus 100 to the operation apparatus 200. Further, in each of the figures, an alternate long and short dash line frame indicates the range of the display control authority assigned from the camera apparatus 300 to the lens apparatus 100. In the display data relating to the lens apparatus 100, information relating to the lens apparatus 100 and information relating to the operation apparatus 200 are combined. The display data relating to the combined information may be displayed on the display unit 304 of the camera apparatus 300 and checked by the user.

In a case where an operation event occurs in the operation member 301 of the camera apparatus 300, information about the operation event is transmitted to the lens apparatus 100 or the operation apparatus 200 to which the display control authority has been assigned. As a result, the display data relating to the lens apparatus 100 and the display data relating to the operation apparatus 200 may be updated based on operation of the operation member 301, and setting of the lens apparatus 100 and the operation apparatus 200 may be changed.

The display control authority of the imaging unit having the above-described configuration assigned to another imaging unit may be further assigned to the other imaging unit. Therefore, information in the imaging unit not directly communicably connected can be received and displayed. The configuration of the imaging apparatus is not limited to the configuration including the lens apparatus 100, the operation apparatus 200, and the camera apparatus 300, and for example, a plurality of operation apparatuses 200 may be included or the other type of imaging unit may be included. Further, the camera apparatus 300 may include a display control authority management unit 306 similar to the display control authority management unit 106 of the lens apparatus 100, and may manage assignment (belongingness) of the display control authority. In a case where the imaging apparatus includes three or more imaging units as in the present exemplary embodiment, the belonging state of the display control authority may become unclear or return of the display control authority may become difficult. Therefore, it is preferable that the belonging state of the display control authority be managed, the belonging state be displayed on the display unit, or forcible return of the display control authority be made possible. In a case where release of the display control authority is restricted, information about the restriction may be displayed on the display unit, or the release may be limited based on the restriction. As described above, according to the present exemplary embodiment, it is possible to provide the imaging unit advantageous in displaying information on another imaging unit.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Although the preferred exemplary embodiments of the present disclosure are described above, the present disclosure is not limited to these exemplary embodiments, and can be variously modified and alternated within the scope of the present disclosure.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-030254, filed Feb. 28, 2022, which is hereby incorporated by reference herein in its entirety.

What is claimed is:

1. A unit, comprising:
a processing unit configured to generate display data about at least one of a state and setting of the unit; and
a transmission unit configured to transmit information,
wherein the unit is communicably connected to another unit including a display unit, and
wherein the processing unit causes the transmission unit to transmit the display data to the other unit based on a notification that the display unit is in a displayable state, from the other unit.

2. The unit according to claim 1, wherein the display data includes a character code.

3. The unit according to claim 1, wherein the state and the setting relate to a function of the unit.

4. The unit according to claim 1, wherein the unit is any of a lens apparatus, an operation apparatus configured to operate the lens apparatus, and a camera apparatus including an imaging device configured to capture an image formed by the lens apparatus.

5. The unit according to claim 1, wherein, in a case where a display control authority for the display unit of the other unit is assigned from the other unit, the processing unit causes the transmission unit to transmit the display data to the other unit.

6. The unit according to claim 5, wherein the processing unit requests the display control authority to the other unit.

7. The unit according to claim 5, wherein the processing unit assigns the display control authority assigned from the other unit to a unit different from the other unit.

8. The unit according to claim 1, wherein the processing unit causes the transmission unit to transmit the display data to the other unit based on a request from the other unit.

9. The unit according to claim 1, wherein the processing unit generates the display data about only a part of a display area of the display unit designated by the other unit.

10. The unit according to claim 1,
wherein the unit is communicably connected to still another unit, and
wherein the processing unit generates the display data about at least one of a state and setting of the still other unit.

11. The unit according to claim 10, wherein the processing unit generates the display data about at least one of a state and setting of each of two different operation apparatuses each configured to operate a lens apparatus.

12. The unit according to claim 11, wherein the two operation apparatuses operate respective optical members different from each other in the lens apparatus.

13. The unit according to claim 1, wherein the processing unit causes the transmission unit to transmit information indicating that a function of generating the display data is held.

14. The unit according to claim 1, wherein the processing unit generates display data about information indicating that a function of generating the display data is held, and causes the transmission unit to transmit the display data.

15. The unit according to claim 1, wherein the processing unit changes a frequency of causing the transmission unit to transmit the display data based on an information amount of the display data.

16. A unit, comprising:
a display unit;
a transmission unit configured to transmit a notification that the display unit is in a displayable state to another unit different from the unit;
a reception unit configured to receive display data about at least one of a state and setting of the other unit from the other unit; and
a processing unit configured to cause the display unit to display the display data.

17. The unit according to claim 16, wherein the display data includes a character code.

18. The unit according to claim 16, wherein the state and the setting relate to a function of the other unit.

19. The unit according to claim 16, wherein the unit is any of a lens apparatus, an operation apparatus configured to operate the lens apparatus, and a camera apparatus including an imaging device configured to capture an image formed by the lens apparatus.

20. The unit according to claim 16, wherein the processing unit assigns display control authority for the display unit to the other unit.

21. The unit according to claim 20, wherein, in a case where assignment of the display control authority to the other unit is requested, the processing unit assigns the display control authority to the other unit.

22. The unit according to claim 20, wherein, in a case where assignment of the display control authority is requested from the other unit, the processing unit assigns the display control authority to the other unit.

23. The unit according to claim 16, wherein the processing unit requests the display data to the other unit.

24. The unit according to claim 16, wherein the processing unit causes the display unit to display the display data about only a part of a display area of the display unit.

25. The unit according to claim 16, wherein the processing unit causes the transmission unit to transmit information inquiring whether a function of generating the display data is held.

26. An imaging apparatus, comprising:
the unit according to claim 1; and
another unit communicably connected to the unit and including a display unit configured to display the display data.

27. An imaging apparatus, comprising:
the unit according to claim 16; and
another unit communicably connected to the unit and including a transmission unit configured to transmit the display data.

28. A non-transitory computer-readable storage medium storing a program for executing a method to control a unit including a transmission unit configured to transmit information, the unit being communicably connected to another unit including a display unit, the method comprising:
generating display data about at least one of a state and setting of the unit; and
causing the transmission unit to transmit the display data to the other unit based on a notification that the display unit is in a displayable state from the other unit.

29. A non-transitory computer-readable storage medium that stores a program for executing a method to control a unit including a display unit, a transmission unit configured to transmit information, and a reception unit configured to receive information, the method comprising:
causing the transmission unit to transmit notification that the display unit is in a displayable state to another unit different from the unit;
causing the reception unit to receive display data about at least one of a state and setting of the other unit from the other unit; and
causing the display unit to display the display data.
